(19) United States
(12) Patent Application Publication
(10) Pub. No.: US 2006/0024546 A1
(43) Pub. Date: Feb. 2, 2006

(54) Fullerene-based electrolyte for fuel cells

(75) Inventors: Raouf O. Loutfy, Tucson, AZ (US); Perumal Pugazhendhi, Tucson, AZ (US); Ken Tasaki, Goleta, CA (US); Arunkumar Venkatesan, Santa Barbara, CA (US)

Correspondence Address: CISLO & THOMAS, LLP, 233 WILSHIRE BLVD, SUITE 900, SANTA MONICA, CA, 90401-1211, US

(73) Assignee: MC Research & Innovation Corp and MER Corporation

(21) Appl. No.: 11/152,011

(22) Filed: Jun. 14, 2005

Related U.S. Application Data
(63) Continuation-in-part of application No. 10/867,380, filed on Jun. 12, 2004, now Pat. No. 6,949,304.
(60) Provisional application No. 60/477,971, filed on Jun. 12, 2003.
(60) Provisional application No. 60/500,603, filed on Sep. 5, 2003.

(51) Int. Cl. H01M 8/10

(52) U.S. Cl. 429/33

(57) ABSTRACT

Fullerene materials are incorporated in minor amounts into various polymeric materials to enhance the low relative humidity proton conductivity properties of the polymeric material. The resulting proton conductors may be used as polymer electrolyte membranes in fuel cells operative over a wide range of relative humidity conditions and over a wide range of temperatures from below room temperature to above the boiling point of water.

### CROSS-REFERENCES TO RELATED APPLICATIONS

This patent application is a continuation-in-part of U.S. patent application Ser. No. 10/867,380 filed Jun. 12, 2004, which claims the benefit of U.S. Provisional Application No. 60/477,971, filed Jun. 12, 2003, and U.S. Provisional Application No. 60/500,603, filed Sep. 5, 2003.

### STATEMENT REGARDING FEDERALLY-SPONSORED RESEARCH AND DEVELOPMENT

This invention was made with Government support under Government Contract No. DAAD19-03-C-0024, awarded by the United States Department of Defense. The Government has certain rights in the invention.

### BACKGROUND OF THE INVENTION

The present invention relates to polymer electrolyte membranes for use in fuel cells, and more particularly, to the utilization of fullerene materials for enhancing the low relative humidity proton conductivity properties of such polymeric membranes.

A steadily increasing demand for portable electric power has stimulated interest in the development of more efficient and more powerful fuel cell devices. A polymer electrolyte membrane (PEM) fuel cell is a strong candidate as a portable power source for commercial applications primarily because of its low weight and high power density.

The operation of a PEM fuel cell relies upon the proton conductivity properties of a polymeric membrane positioned between the two electrodes of the cell, to transport protons internally from one electrode to the other. The membrane must also have no electronic conductivity, good chemical and mechanical stability, and sufficient gas impermeability to prevent cross over of the fuel. For many years now, the membrane of choice has been a sulfonated perfluoro polymer known as Nafion®, commercially available from DuPont.

The major drawback to Nafion® as the ideal polymer electrolyte membrane in fuel cells is that its proton conductivity depends on the water content in the membrane, in which proton transport is based on the diffusion of hydronium ion (H₃O⁺). In order to retain its high proton conductivity, Nafion® membrane requires the use of pre-humidified gases at an operating temperature under 80° C. Such requirements considerably increase the cost, size and complexity of PEM fuel cells using Nafion®. Nafion® membranes cannot perform under dry or low relative humidity conditions nor above the boiling point of water, despite the faster chemical reaction and increased output that would result from the higher temperature. Furthermore, operating at the lower temperature required by Nafion® increases the risk of carbon monoxide poisoning of the fuel cell catalyst.

Various attempts have been made to develop water-free proton conductive membranes for PEM fuel cells that do not have the low temperature and high relative humidity requirements of Nafion®. One such attempt, for example, is described in the Hinokuma et al. U.S. Pat. No. 6,495,290, issued Dec. 17, 2002, incorporated herein by reference. The proton conductors employed by Hinokuma et al. are based on fullerene derivatives containing acidic functional groups such as —OH or —SO₃H, and are designed to operate under dry conditions over a wide range of temperatures. The proton conductors are described as being either compacted powder of the fullerene derivatives, or mixed with a small amount, generally 20 weight percent or less, of a film-forming polymeric material, such as polytetrafluoroethylene, polyvinylidene fluoride or polyvinyl alcohol. The patent cautions against employing the polymer in amounts any greater than 20 weight percent, at the risk of degrading the proton conductivity of the fullerene derivative. Furthermore, there is no hint in the Hinokuma et al. patent of using the fullerene derivative in combination with Nafion®.

### SUMMARY OF THE INVENTION

The present invention resides in the discovery that proton conductive fullerene materials, as well as non-conductive fullerene materials that nevertheless facilitate the overall proton conductivity of a conductive membrane, including but not limited to the fullerene derivatives described in Hinokuma et al., U.S. Pat. No. 6,495,290, can be used in minor amounts, even as low as about 1% by weight, to enhance the low relative humidity proton conductivity properties of a variety of polymeric materials, even including Nafion® itself. The proton conductive fullerene materials used in the present invention contain either bound water, or a plurality of functional groups with lone pair electrons, or a combination thereof, and may be incorporated into the polymeric material by doping or by mechanical mixing or by chemical reaction forming covalent bonds. The resulting proton conductors may be used as polymer electrolyte membranes in fuel cells operative over a wide range of relative humidity conditions and over a wide range of temperatures from below room temperature to above the boiling point of water.

The present invention includes the use of proton conductive and facilitating yet non-conductive fullerene materials to enhance the low relative humidity proton conductivity properties of polymeric materials. It also includes the proton conductors resulting from such use, as well as fuel cells employing such proton conductors.

### BRIEF DESCRIPTION OF THE SEVERAL VIEWS OF THE DRAWINGS

FIG. 1 is a graph showing the results of measuring the proton conductivities as a function of relative humidity at 30° C. of a bare Nafion® membrane (plot a) in comparison with Nafion® membrane doped with 1% by weight of various fullerene materials (plots b, c and d) and polyethylene oxide-fullerene materials composites (plots e and f).

FIG. 2 is a graph showing the polarization curves of a PEM fuel cell measured at 120° C. under 25% relative humidity with a bare Nafion® membrane (plot a) in comparison with Nafion® membrane doped with 1% by weight of fullerene materials (plots b and c); and

FIG. 3 is a sectional view showing a fuel cell that employs a proton conductor in accordance with the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

In accordance with the present invention, proton conductive fullerene materials (and also non-conductive fullerene materials that nevertheless are capable of facilitating the overall conductivity of the membrane) are employed to enhance the low relative humidity proton conductivity properties of polymeric materials for use as polymer electrolyte membranes in fuel cells. In this context, the term “low relative humidity” is used to signify relative humidities less than about 50%.

The proton conductive fullerene materials used in accordance with the present invention are fullerene materials containing bound water, or a plurality of functional groups with lone pair electrons, or a combination thereof. Fullerene materials containing a plurality of functional groups with lone pair electrons include, but are not limited to, all of the various fullerene derivatives described in the Hinokuma et al. U.S. Pat. No. 6,495,290, incorporated herein by reference, as having functional groups represented by the formula —XH where X is an arbitrary atom or atomic group having a bivalent bond, and more specifically by the formula —OH or —YOH where Y is an arbitrary atom or atomic group having a bivalent bond, and preferably the functional groups —OH, —OSO₃H, —COOH, —SO₃H or —OPO(OH)₃. Other functional groups with lone pair electrons include basic functional groups, such as —NH₂, ═NH and ≡N.

Fullerene materials containing bound water encompass just about all fullerene materials, with or without functional groups, even including C₆₀ itself. This is so because all fullerenes inherently contain a certain amount of bound water in their molecules which is extremely difficult to drive out in its entirety. In this respect, all fullerenes and fullerene derivatives are inherently water carriers capable of supporting some degree of proton transport through the diffusion of hydronium ions. This is independent of the proton hopping mechanism of proton transport between functional groups that is exhibited by the fullerene derivatives. For this reason, C₆₀ itself, even without functionalization, is included as a proton conductive fullerene material, and surprisingly has been found to be one of the preferred proton conductive fullerene materials for use in the present invention.

Other preferred proton conductive fullerene materials for use in the present invention are polyhydroxylated fullerene, polysulfonated fullerene and polyhydroxylated polysulfonated fullerene.

The present invention allows for significant flexibility in selection of the base polymeric material whose proton conductivity properties are to be enhanced by incorporation of the proton conductive fullerene materials. The selection will generally be made based upon the other requisite properties for a fuel cell polymer electrolyte membrane, such as no electronic conductivity, good chemical and mechanical stability, and sufficient gas impermeability to prevent cross over of the fuel. Since Nafion® is well known to exhibit these properties and has long been the membrane of choice for PEM fuel cell applications, it is the logical preferred polymeric material for use in the present invention. Nafion® itself is a copolymer of tetrafluoroethylene and perfluoro-3,(5+n)-dioxa-4-methyl-(6+n)-alkenesulfonyl halide in acid or ionomer form, wherein n is equal to 1 or greater.

Other base polymers are equally contemplated within the present invention, including hydrocarbon based polymers, including, but not limited to, poly(ether ether ketone), poly(arrylene ether sulfone), poly(phenylene ether), sulfonated poly(ether ether ketone), sulfonated poly(ethersulfone), sulfonated poly(phenylquinoxaline), sulfonated poly(arylene sulfone), sulfonated poly(arylene ether sulfone), sulfonated poly(phenylene sulfide), sulfonated poly(imides), sulfonated poly(benzimidazole), sulfonated poly(phosphazine), sulfonated poly(sulfone), and the like. Other preferred polymeric materials include polymers of perfluoro sulfonic acids and sulfonated perfluoro polymers in general, polyethylene oxide, polystyrene and sulfonated polystyrene.

The requisite amount of proton conductive fullerene material to be incorporated into the polymeric material for enhancing the low relative humidity proton conductivity properties of the polymeric material, is surprisingly small, despite the negative teachings in this regard of Hinokuma et al., U.S. Pat. No. 6,495,290, which cautions against adding polymer to fullerene derivatives in amounts any greater than 20 weight percent, at the risk of degrading the proton conductivity of the fullerene derivative. The present invention employs the reverse approach and adds the fullerene material to the polymer in a minor amount relative to the polymer. This amount will generally be less than about 30% by weight, and in most instances, within the range of from about 1 to about 10% by weight.

The actual incorporation of the fullerene material into the base polymeric material may be carried out in a variety of ways, depending upon the form of the starting materials. For example, if the base polymer is already in membrane or film form, such as the commercially available Nafion® membrane, the fullerene material may be doped into the polymeric material by soaking the membrane in a doping solution of the fullerene material. Alternatively, the components may be mixed together in solution, for example, using supercritical CO₂, and then either casting a composite film or membrane, or evaporating the solvent to form a powder and then pelletizing the powder into a pelletized membrane. In some instances, it may be desirable to covalently link the fullerene material to the polymeric material through chemical reaction therebetween, and the film or membrane may comprise a layer-by-layer structure.

Other additives may desirably be incorporated into the polymeric material in conjunction with the fullerene material. For example, when using a relatively high loading of fullerene that may cause the final membrane to become brittle, it may be desirable to add a brittleness inhibiting amount of a plasticizer for the polymeric material, such as low molecular weight polyethylene oxide, low molecular weight polyethylene imine, or carbon disulfide. Also, it may be desirable to aid the incorporation of the requisite amount of the fullerene material into the polymeric material by the addition of a fullerene-uptake adjuvant, such as silica, alumina or titania. Silica, in amounts up to about 10% by weight, has been found to be particularly suitable for this purpose.

The invention is further illustrated by way of the following examples.

### EXAMPLE 1

Nafion® 117 membrane obtained from DuPont was first boiled for 30 minutes with 3% hydrogen peroxide solution to remove organic impurities. The film was then rinsed several times with de-ionized water. The film was then boiled with 1M sulfuric acid for an hour to remove inorganic minerals. The membrane was again rinsed with de-ionized water and soaked in isopropyl alcohol until use. 1 wt % of dried C₆₀(OH)₁₂ was mixed with 0.8 g of Nafion® ionomer solution obtained from DuPont. The wet membrane was soaked in a closed vial filled with this mixture of C₆₀(OH)₁₂ and Nafion® ionomers for 24 hours. The membrane was then removed from the vial and dried in the vacuum oven. The resulting product was a Nafion® membrane doped with 1 wt % C₆₀(OH)₁₂.

### EXAMPLE 2

Example 1 was repeated, substituting C₆₀(OSO₃H)₄(OH)₈ for the C₆₀(OH)₁₂, to obtain a Nafion® membrane doped with 1 wt % C₆₀(OSO₃H)₄(OH)₈.

### EXAMPLE 3

Example 1 was repeated, substituting C₆₀ for the C₆₀(OH)₁₂, to obtain a Nafion® membrane doped with 1 wt % C₆₀.

### EXAMPLE 4

A composite membrane consisting of polyethylene oxide and 1 wt % C₆₀(OSO₃H)₄(OH)₈ was prepared by mixing the two ingredients together in solution and then solution casting the membrane on Teflon sheet.

### EXAMPLE 5

Example 4 was repeated, this time increasing the amount of C₆₀(OSO₃H)₄(OH)₈ to 20 wt %.

### EXAMPLE 6

A composite membrane consisting of sulfonated polystyrene and 10 wt % C₆₀(OSO₃H)₄(OH)₈ was prepared by mixing the two ingredients together in solution and then solution casting the membrane on Teflon sheet.

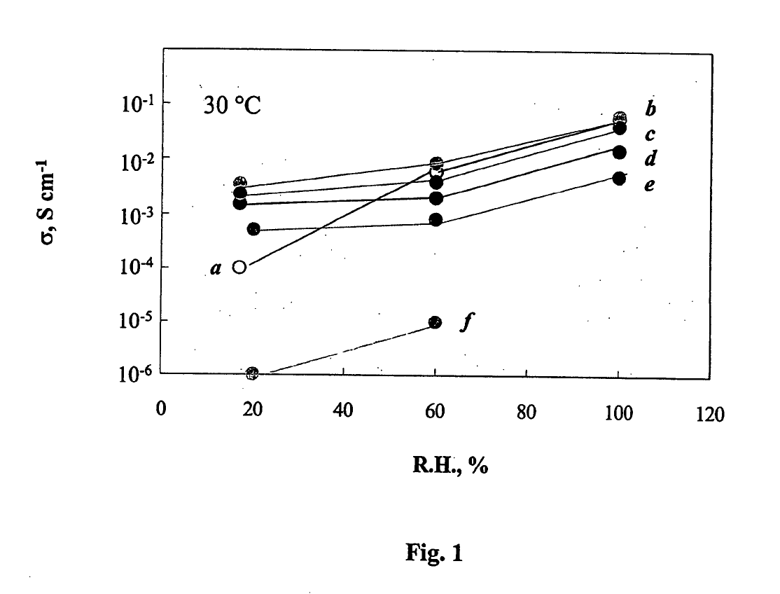

The proton conductivities of the membranes prepared in accordance with Examples 1-5, as well as that of a bare Naflon® membrane, were measured at 30° C. (i.e., low temperature) at varying relative humidities ranging from 20% to 100%. FIG. 1 is a graph showing these proton conductivities (σ) as a function of relative humidity (R.H.). In FIG. 1, plot a is that of the bare Nafion® membrane; plot b corresponds to the Nafion® membrane doped with 1 wt % C₆₀ (Example 3); plot c corresponds to the Nafion® membrane doped with 1 wt % C₆₀(OH)₁₂ (Example 1); plot d corresponds to the Nafion® membrane doped with 1 wt % C₆₀(OSO₃H)₄(OH)₈ (Example 2); plot e corresponds to the composite membrane of polyethylene oxide and 20 wt % C₆₀(OSO₃H)₄(OH)₈ (Example 5); and plot f corresponds to the composite membrane of polyethylene oxide and 1 wt % C₆₀(OSO₃H)₄(OH)₈ (Example 4). As can readily be seen from comparing plots b, c and d to plot a in FIG. 1, doping of the Nafion® membrane with the fullerene materials, even in such small amounts as 1 wt %, significantly increases the low relative humidity proton conductivity of the membrane. Furthermore, a comparison of plots e and f in FIG. 1 shows that in the case of the polyesthylene oxide membrane, increasing the fullerene loading from 1 to 20 wt % greatly increases the proton conductivity of the membrane over the entire relative humidity range.

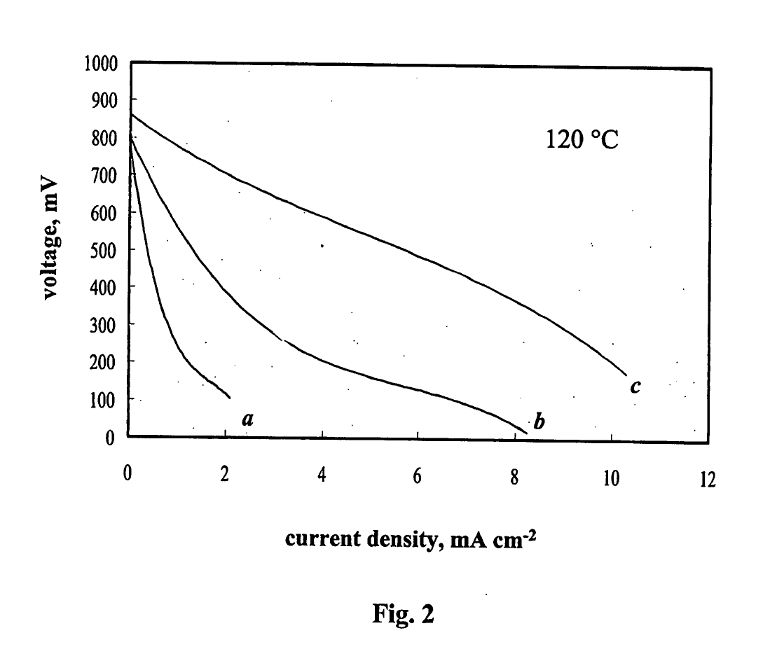

The PEM fuel cell performance of the membranes prepared in accordance with is Examples 2 and 3, as well as that of a bare Nafion® membrane, were measured at 120° C. (i.e., high temperature) and 25% relative humidity (i.e., low relative humidity), with the fuels being hydrogen and air, the pressure being ambient, and the platinum loading being 0.2 mg cm −2. FIG. 2 is a graph showing the resulting polarization curves. In FIG. 2, plot a is that of a bare Nafion® membrane; plot b corresponds to the Nafion® membrane doped with 1 wt % C₆₀ (Example 3); and plot c corresponds to the Nafion® membrane doped with 1 wt % C₆₀(SO₃H)₄(OH)₈ (Example 2). It is clear from FIG. 2 that doping of the Nafion® membrane with the fullerene materials, even in such small amounts as 1 wt %, significantly increases the high temperature, low relative humidity PEM fuel cell performance of the membrane.

The proton conductivities of the membranes prepared in accordance with Examples 1-3 and 6, as well as that of a bare Nafion® membrane and a bare sulfonated polystyrene membrane, were also measured at 120° C. (i.e., high temperature) and 25% relative humidity (i.e., low relative humidity). The results are listed in Table 1, below.

TABLE 1

| | Proton Conductivity |
|---|---|
| Membrane | S cm−1 |
| Bare Nafion | 7 × 10 − 5 |
| Example 1 | 6 × 10 − 4 |
| Example 2 | 3.7 × 10 − 4 |
| Example 3 | 7 × 10 − 4 |
| Bare Sulfonated Polystyrene | 10 − 6 |
| Example 6 | 10 − 5 |

From the proton conductivity data listed in Table 1, it can be seen that the incorporation of the fullerene materials into the membranes, in the case of both the Nafion® membrane and the sulfonated polystyrene membrane, increases the high temperature, low relative humidity proton conductivity of the membrane by an order of magnitude.

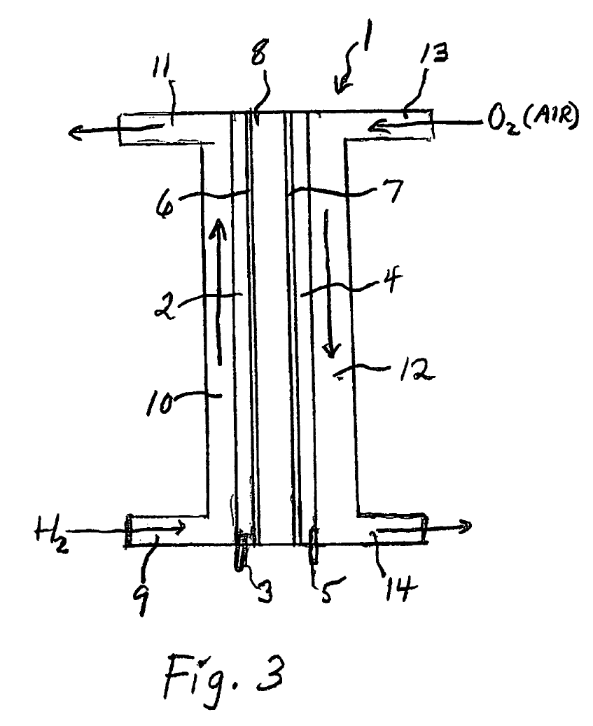

It is apparent from the above test results that the proton conductors with enhanced low relative humidity proton conductivity properties in accordance with the present invention, are well suited for use as polymer electrolyte membranes in fuel cells. An example of a fuel cell using the proton conductor of this invention is shown in FIG. 3. Referring to FIG. 3, a fuel cell 1 has a hydrogen electrode 2 provided with a terminal 3, and an oxygen electrode 4 provided with a terminal 5. The hydrogen electrode 2 is provided on its inside face with a catalyst 6, and the oxygen electrode 4 is provided on its inside face with a catalyst 7. Positioned between the two electrodes adjacent to the catalysts 6 and 7 is a proton conductor 8 in accordance with the present invention. When the fuel cell is in use, hydrogen is supplied from an inlet 9 on the side of the hydrogen electrode 2, passes through a flow passage 10, and is discharged from an outlet 11. As hydrogen passes through the flow passage 10, protons are generated and migrate together with proton generated in the proton conductor 8 to the side of the oxygen electrode 4, where they react with oxygen (air) which has been supplied in a flow passage 12 from an inlet 13 and flows toward an outlet 14, to generate a desired electromotive force.

While the present invention has been described with regards to particular embodiments, it is recognized that additional variations of the present invention may be devised without departing from the inventive concept.

What is claimed is:

1. A method of enhancing the low relative humidity proton conductivity properties of a polymeric material for use as a polymer electrolyte membrane in a fuel cell, comprising incorporating into said polymeric material a proton conductivity enhancing amount of a proton conductive fullerene material.

2. The method of claim 1, wherein said fullerene material is incorporated in a minor amount relative to said polymeric material.

3. The method of claim 2, wherein said amount is less than about 30% by weight.

4. The method of claim 3, wherein said amount is within the range of from about 1 to about 10% by weight.

5. The method of claim 1, wherein said fullerene material contains bound water, or a plurality of functional groups with lone pair electrons, or a combination thereof.

6. The method of claim 1, wherein said fullerene material comprises C₆₀.

7. The method of claim 1, wherein said fullerene material comprises polyhydroxylated fullerene, polysulfonated fullerene, or polyhydroxylated polysulfonated fullerene.

8. The method of claim 1, wherein said polymeric material is a sulfonated perfluoro polymer, polyethylene oxide, polystyrene or sulfonated polystyrene.

9. The method of claim 8, wherein said polymeric material is a copolymer of tetrafluoroethylene and perfluoro-3,(5+n)-dioxa-4-methyl-(6+n)-alkenesulfonyl halide in acid or ionomer form, wherein n is equal to 1 or greater.

10. The method of claim 1, wherein said polymeric material is in the form of a membrane, and said fullerene material is doped into said membrane.

11. The method of claim 1, wherein said polymeric material is selected from the group consisting of poly(ether ether ketone), poly(arrylene ether sulfone), poly (phenylene ether), sulfonated poly(ether ether ketone), sulfonated poly(ethersulfone), sulfonated poly(phenylquinoxaline), sulfonated poly(arylene sulfone), sulfonated poly(arylene ether sulfone), sulfonated poly(phenylene sulfide), sulfonated poly(imides), sulfonated poly(benzimidazole), sulfonated poly(phosphazine), and sulfonated poly(sulfone).

12. A proton conductor comprising a polymeric material and a minor amount of a proton conductive fullerene material incorporated into said polymeric material, said amount being effective to enhance the low relative humidity proton conductivity properties of said polymeric material.

13. The proton conductor of claim 12, wherein said amount is less than about 30% by weight.

14. The proton conductor of claim 13, wherein said amount is within the range of from about 1 to about 10% by weight.

15. The proton conductor of claim 12, wherein said fullerene material contains bound water, or a plurality of functional groups with lone pair electrons, or a combination thereof.

16. The proton conductor of claim 12, wherein said fullerene material comprises C₆₀.

17. The proton conductor of claim 12, wherein said fullerene material comprises polyhydroxylated fullerene, polysulfonated fullerene, or polyhydroxylated polysulfonated fullerene.

18. The proton conductor of claim 12, wherein said polymeric material is a sulfonated perfluoro polymer, polyethylene oxide, polystyrene or sulfonated polystyrene.

19. The proton conductor of claim 18, wherein said polymeric material is a copolymer of tetrafluoroethylene and perfluoro-3,(5+n)-dioxa-4-methyl-(6+n)-alkenesulfonyl halide in acid or ionomer form, wherein n is equal to 1 or greater.

20. The proton conductor of claim 12, wherein said polymeric material is in the form of a membrane, and said fullerene material is doped into said membrane.

21. The proton conductor of claim 12, wherein said polymeric material is selected from the group consisting of poly(ether ether ketone), poly(arrylene ether sulfone), poly (phenylene ether), sulfonated poly(ether ether ketone), sulfonated poly(ethersulfone), sulfonated poly(phenylquinoxaline), sulfonated poly(arylene sulfone), sulfonated poly(arylene ether sulfone), sulfonated poly(phenylene sulfide), sulfonated poly(imides), sulfonated poly(benzimidazole), sulfonated poly(phosphazine), and sulfonated poly(sulfone).

22. A fuel cell comprising a first electrode, a second electrode, and a proton conductor that is positioned between the first and second electrodes, said proton conductor comprising a polymeric material and a minor amount of a proton conductive fullerene material incorporated into said polymeric material, said amount being effective to enhance the low relative humidity proton conductivity properties of said polymeric material.

23. The fuel cell of claim 22, wherein said amount is less than about 30% by weight.

24. The fuel cell of claim 23, wherein said amount is within the range of from about 1 to about 10% by weight.

25. The fuel cell of claim 22, wherein said fullerene material contains bound water, or a plurality of functional groups with lone pair electrons, or a combination thereof.

26. The fuel cell of claim 22, wherein said fullerene material comprises C₆₀.

27. The fuel cell of claim 22, wherein said fullerene material comprises polyhydroxylated fullerene, polysulfonated fullerene, or polyhydroxylated polysulfonated fullerene.

28. The fuel cell of claim 22, wherein said polymeric material is a sulfonated perfluoro polymer, polyethylene oxide, polystyrene or sulfonated polystyrene.

29. The fuel cell of claim 28, wherein said polymeric material is a copolymer of tetrafluoroethylene and perfluoro-3,(5+n)-dioxa-4-methyl-(6+n)-alkenesulfonyl halide in acid or ionomer form, wherein n is equal to 1 or greater.

30. The fuel cell of claim 22, wherein said polymeric material is in the form of a membrane, and said fullerene material is doped into said membrane.

31. The fuel cell of claim 22, wherein said polymeric material is selected from the group consisting of poly(ether ether ketone), poly(arrylene ether sulfone), poly (phenylene ether), sulfonated poly(ether ether ketone), sulfonated poly(ethersulfone), sulfonated poly(phenylquinoxaline), sulfonated poly(arylene sulfone), sulfonated poly(arylene ether sulfone), sulfonated poly(phenylene sulfide), sulfonated poly(imides), sulfonated poly(benzimidazole), sulfonated poly(phosphazine), and sulfonated poly(sulfone).
